(19) United States
(12) Patent Application Publication
(10) Pub. No.: US 2007/0237537 A1
(43) Pub. Date: Oct. 11, 2007

(54) Image forming apparatus and method of presenting data pertaining to the image forming apparatus

(76) Inventors: Takashi Hasegawa, Kanagawa (JP); Saburoh Sasaki, Tokyo (JP)

Correspondence Address: MORRISON & FOERSTER LLP, 1650 TYSONS BOULEVARD, SUITE 400, MCLEAN, VA, 22102, US

(21) Appl. No.: 11/730,183

(22) Filed: Mar. 29, 2007

(30) Foreign Application Priority Data
Apr. 7, 2006 (JP) 2006-106616

(51) Int. Cl. G03G 15/00

(52) U.S. Cl. 399/81

(57) ABSTRACT

An image forming apparatus is disclosed that includes an image data storage unit configured to store image data pertaining to operation procedures, a detection unit configured to detect an abnormality in the image forming apparatus and an operator-operation status of the image forming apparatus, a read unit configured to read from the image data storage unit relevant image data pertaining to operation procedures relevant to the abnormality and the operator-operation status detected by the detection unit, and a display unit configured to display the relevant image data read by the read unit.

### BACKGROUND OF THE INVENTION

1. Field of the Invention

The present invention relates to an image forming apparatus, and an image display method and audio replay method implemented in the image forming apparatus.

2. Description of the Related Art

Operation procedures for operating an image forming apparatus may be described using diagrams and text in a manual, for example. FIG. 1 shows an exemplary description of operation procedures for operating an image forming apparatus. Specifically, FIG. 1 shows diagrams indicated in a manual that illustrate operation procedures for exchanging a toner cartridge. The illustrated operation procedures involve opening a cover of the image forming apparatus and installing a new cartridge taken out of a package into the image forming apparatus. FIG. 2 shows another exemplary description of operation procedures for an image forming apparatus. Specifically, FIG. 2 shows a description of operation procedures indicated in a manual for installing/removing toner that uses a combination of diagrams and text. FIG. 3 shows another exemplary description of operation procedures. In the example of FIG. 3, LEDs arranged at an image forming apparatus may flicker when an abnormality occurs so that an operator may be informed of the abnormality. The informed operator may then refer to a manual that indicates operation procedures according to the location of the flickering LED. In another example, the number of remaining operation procedure steps to be performed may be indicated in accordance with the progress of operation procedures (see Japanese Laid-Open Patent No. 2003-005586).

Also, Japanese Patent No. 3274439 discloses a technique implemented in an image forming apparatus that involves displaying moving image data representing a predetermined sequence of operation procedures on display means upon detecting that such predetermined operation procedures need to be performed by the operator (e.g., in the case of using a LCD display, images are displayed at 70-200 ms timings in order to prevent the occurrence of after-images). According to the disclosed technique, moving image data providing operation guidance for various types of operation procedures are stored in a memory of the apparatus. Also, sequence programs are stored in the memory for displaying appropriate moving images and text upon detecting the required operation procedures.

However, according to the disclosure of Japanese Laid-Open Patent No. 2003-005586, it may be difficult for an operator to understand the exact operation procedures to be performed based on the display of images and text describing the operation procedures. For example, in the case of toner exchange operations, an operator may be instructed to shake the toner container in order to mix the toner; however, the display of images and text according to the above disclosure does not indicate how fast the toner container has to be shaken.

According to the disclosure of Japanese Patent No. 3274439, an image forming apparatus may be configured to detect instances where the display of operation procedure guidance is necessary (e.g., no paper, no toner, full disposal toner), and iteratively display the appropriate guidance in the form of a moving image. However, it is quite difficult for a novice operator to master operation procedures just by having a moving image describing the operation procedures sequence iteratively displayed as in the above disclosure. On the other hand, the display of a moving image may not be necessary (the display of still images may suffice) for a more experienced operator, and time may needlessly be consumed if a moving image is displayed even for such an operator.

### SUMMARY OF THE INVENTION

According to an aspect of the present invention, a technique for providing operation procedure guidance is disclosed for enabling operators of various levels ranging from novice operators to experienced operators to efficiently and accurately perform operation procedures.

According to one embodiment of the present invention, an image forming apparatus is provided that includes:

an image data storage unit configured to store image data pertaining to operation procedures;

a detection unit configured to detect an abnormality in the image forming apparatus and an operator-operation status of the image forming apparatus;

a read unit configured to read from the image data storage unit relevant image data pertaining to operation procedures relevant to the abnormality and the operator-operation status detected by the detection unit; and

a display unit configured to display the relevant image data read by the read unit.

According to anther embodiment of the present invention, an image forming apparatus is provided that includes:

image data storage means for storing image data pertaining to operation procedures;

detection means for detecting an abnormality in the image forming apparatus and an operator-operation status of the image forming apparatus;

read means for reading from the image data storage means relevant image data pertaining to operation procedures relevant to the abnormality and the operator-operation status detected by the detection means; and

display means for displaying the relevant image data read by the read means.

According to another embodiment of the present invention, a method of presenting data pertaining to operation procedures of an image forming apparatus is provided which data include image data pertaining to the operation procedures and which image forming apparatus includes a storage unit for storing the data, the method including the steps of:

detecting an abnormality in the image forming apparatus and an operator-operation status of the image forming apparatus;

reading from the storage unit relevant image data pertaining to operation procedures relevant to the detected abnormality and operator-operation status; and

displaying the read relevant image data.

### BRIEF DESCRIPTION OF THE DRAWINGS

FIG. 1 is a diagram illustrating an exemplary description of operation procedures for an image forming apparatus;

FIG. 2 is a diagram illustrating another exemplary description of operation procedures for an image forming apparatus;

FIG. 3 is a diagram illustrating another exemplary description of operation procedures for an image forming apparatus;

FIG. 4 is a block diagram showing a configuration of an image forming apparatus according to a first embodiment of the present invention;

FIG. 5 is a diagram showing exemplary configurations of a display unit of the image forming apparatus according to the first embodiment;

FIG. 6 is a diagram showing a configuration of an operations input unit of the image forming apparatus according to the first embodiment;

FIGS. 7A and 7B are diagrams illustrating moving image display modes that may be implemented in the image forming apparatus according to the first embodiment;

FIG. 8 is a diagram illustrating moving image data describing predetermined operations procedures according to a first example;

FIG. 9 is a flowchart illustrating exemplary operations for displaying the moving image data shown in FIG. 8;

FIG. 10 is a diagram illustrating moving image data describing predetermined operation procedures according to a second example;

FIG. 11 is a flowchart illustrating exemplary operations for displaying the moving image data shown in FIG. 10;

FIG. 12 is a block diagram showing a configuration of an image forming apparatus according to a second embodiment of the present invention that uses a network;

FIG. 13 is a flowchart illustrating operations of receiving moving image data stored in a server using the network and storing the received moving image data according to the second embodiment;

FIG. 14 is a flowchart illustrating operations of receiving audio data stored in the server using the network and storing the received audio data according to the second embodiment;

FIG. 15 is a block diagram showing a configuration of an image forming apparatus according to a third embodiment of the present invention that uses a network;

FIG. 16 is a flowchart illustrating operations of receiving moving image data stored in a server using the network and displaying the received moving image data according to the third embodiment;

FIG. 17 is a flowchart illustrating operations of receiving audio data stored in the server using the network and replaying the received audio data according to the third embodiment;

FIG. 18 is a block diagram showing a configuration of an image forming apparatus according to a fourth embodiment of the present invention that uses a network;

FIG. 19 is a flowchart illustrating operations of receiving moving image data stored in a server using the network and storing the received moving image data according to the fourth embodiment;

FIG. 20 is a flowchart illustrating operations of receiving audio data stored in the server using the network and storing the received audio data according to the fourth embodiment; and

FIG. 21 is a flowchart illustrating operations of receiving a sequence program stored in the server using the network and storing the received sequence program according to the fourth embodiment.

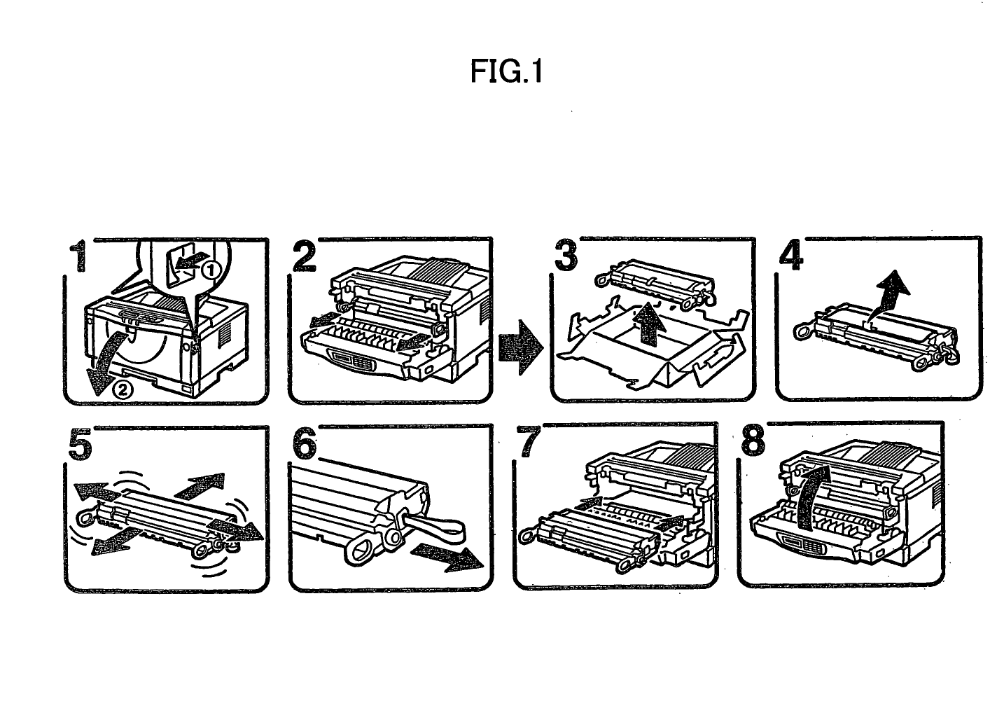

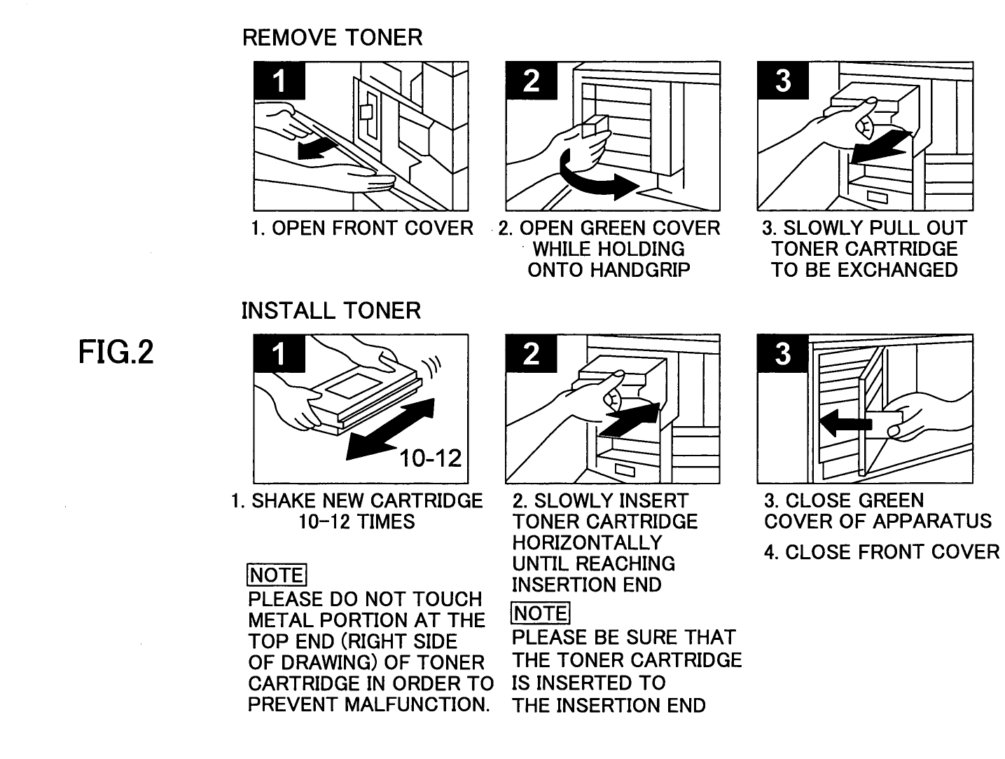

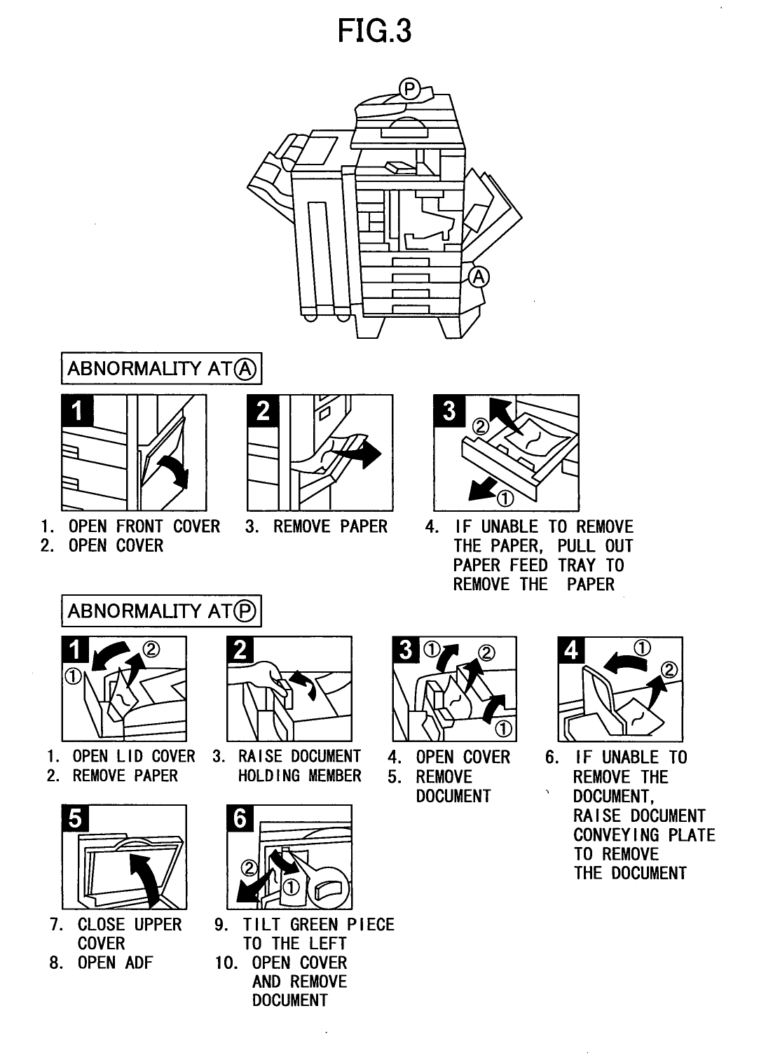

### DESCRIPTION OF THE PREFERRED EMBODIMENTS

In the following, preferred embodiments of the present invention are described with reference to the accompanying drawings.

### First Embodiment

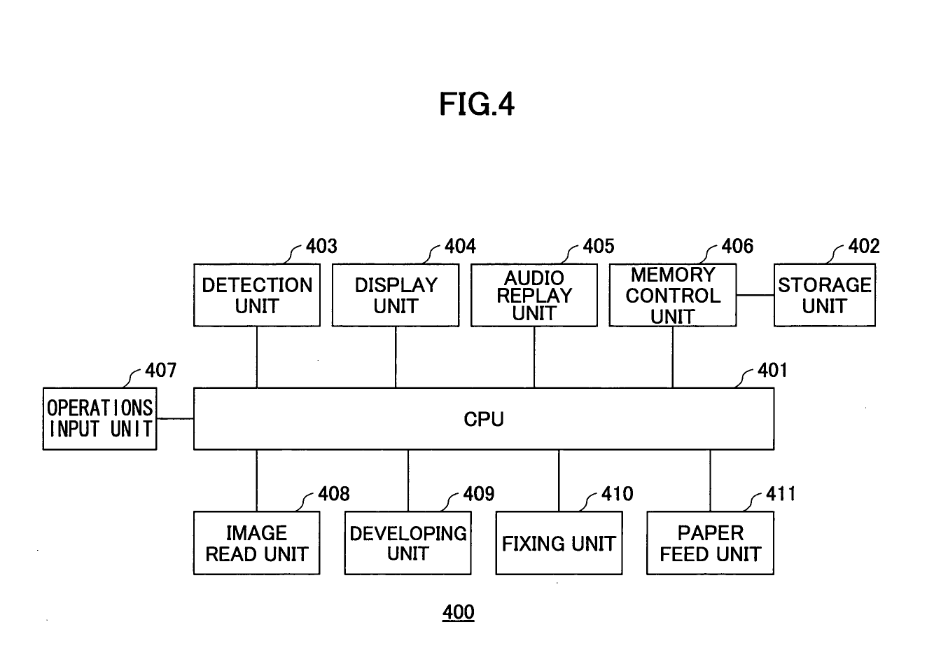

In the following, a first embodiment of the present invention is described with reference to FIGS. 4-11.

FIG. 4 is a block diagram showing a configuration of an image forming apparatus according to an embodiment of the present invention. The illustrated image forming apparatus 400 of FIG. 4 includes a CPU (Central Processing Unit) 401, a storage unit 402, a detection unit 403, a display unit 404, an audio replay unit 405, a memory control unit 406, an operations input unit 407, an image read unit 408, a developing unit 409, a fixing unit 410, and a paper feed unit 411, for example.

The CPU 401 controls overall operations of the image forming apparatus 400.

The storage unit (image data storage unit and/or audio data storage unit) 402 stores image data and/or audio data pertaining to operation procedures.

The detection unit 403 detects the location of the image forming apparatus 400 at which an abnormality is occurring when toner or paper runs out or paper jam occurs, for example. In the case of detecting paper jam, a detection sensor may be arranged at a paper passage, and abnormality of the image forming apparatus 400 and the location at which the abnormality is occurring may be detected based on the detection result of this detection sensor, for example. Also, the detection unit may detect various operator-operation statuses of the image forming apparatus 400 related to the opening/closing of a cover or removal/installation of a toner cartridge by the operator, for example.

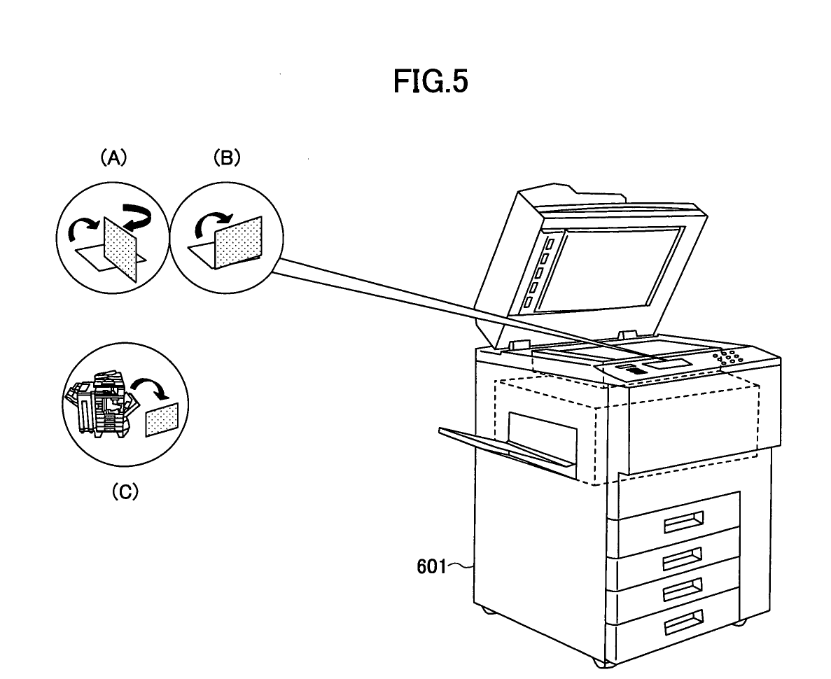

The display unit 404 displays moving image data pertaining to operation procedures that are read from the storage unit 402 on a display screen. FIG. 5 is a diagram showing exemplary configurations of the display unit 404. As is shown in this drawing, in certain preferred embodiments, the display screen of the display unit 404 may be configured to be positionally adjustable. Specifically, in FIG. 5, (A) shows a configuration in which the display screen may be rotated, (B) shows a configuration in which the display screen may turn to stand upright, and (C) shows a configuration in which the display screen is arranged to be detachable and connected by wireless connection so that it may be detached and placed at a desired location.

The audio replay unit 405 replays audio data pertaining to operation procedures that are read from the storage unit 402. For example, the audio replay unit 405 may be a speaker.

The memory control unit (read unit) 406 reads moving image data and/or audio data pertaining to operation procedures that are stored in the storage unit 402.

The operations input unit (input unit) 407 is for inputting various external operations for the image forming apparatus. For example, the operations input unit 407 may be a keyboard and/or a touch panel. The operations input unit 407 includes moving image display mode input keys (moving image display mode input unit) for switching moving image display modes and an operations start input key for starting operation procedures. It is noted that detailed descriptions of the operations input unit 407 are given below.

The image read unit 408 reads a document image. For example, the image read unit 408 may be a scanner.

The developing unit 409 develops a document image. For example, the developing unit 409 may be a developer.

The fixing unit 410 fixes toner onto a recording medium such as paper.

The paper feed unit 411 conveys a recording medium such as paper.

(Operations Input Unit 407)

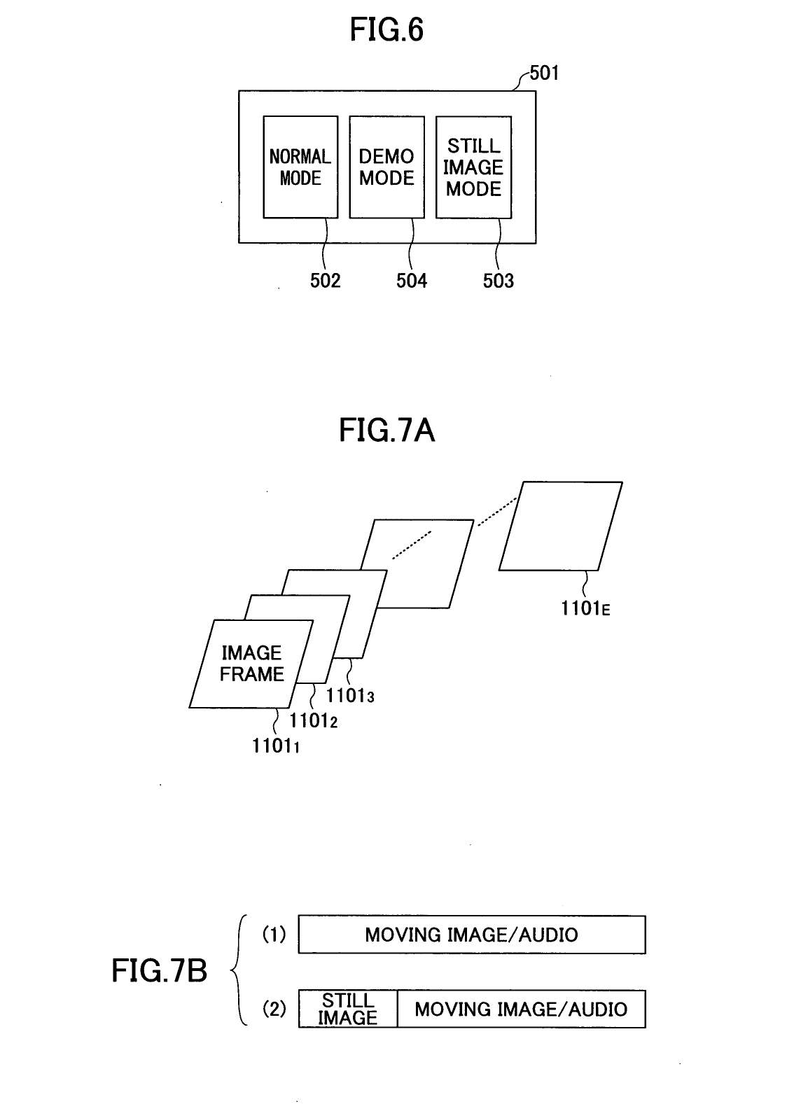

In the following, an exemplary configuration of the operations input unit 407 is described with reference to FIGS. 6 and 7. FIG. 6 illustrates an exemplary moving image display mode input unit of the operations input unit 407 for switching moving image display modes. Specifically, the illustrated moving image display mode input unit 501 of FIG. 6 enables switching between a normal mode 502, a still image mode 503, and a demo mode 504.

The normal mode 502 involves displaying a moving image corresponding to each operation procedure step of predetermined operation procedures such as a toner exchange operation procedures according to operations of the operator (operator-operation status) and other relevant detections made by the detection unit 403, for example. Specifically, in the normal mode 502, a moving image illustrating a next operation procedure step to be performed may be displayed each time the operator completes a current operation procedure step so that the operator may be properly guided through the operation procedures. Also, in this mode, when inappropriate operations such as installing an empty toner cartridge are performed by the operator, the detection unit 403 may detect that the installed toner cartridge does not contain toner and the moving image of the next operation procedure step may be prevented from being displayed.

The still image mode 503 involves displaying still images (pictograms) over a first predetermined part (time period) of operation procedures and then displaying moving images over the remaining part until the operation procedures are complete. It is noted that experienced operators may not need to have moving images displayed for all operation procedure steps. That is, experienced operators may readily perform certain operation procedure steps by simply viewing a still image indicating the initial portion of the operation procedure. By implementing the still image mode 503 as is described above, the process time for performing the operation procedures may be reduced compared to the normal mode 502.

The demo mode 504 involves consecutively displaying moving images of operation procedure steps from the beginning to the end without stopping. In this mode, the operator may view the overall sequence of the operation procedures to determine in advance the nature of the operations such as the level of difficulty and the estimated operations process time. For example, if the operator determines beforehand that the operations are too difficult, he/she may seek assistance from a third person.

In the following, the moving image display modes are described in greater detail.

FIG. 7A is a diagram illustrating an exemplary configuration of a moving image. Specifically, the illustrated moving image of FIG. 7A includes plural consecutive image frames 1101₁ through 1101_{E} (collectively referred to as image frames 1101). FIG. 7B is a diagram illustrating exemplary moving image display methods. Specifically, according to moving image display method (1) of FIG. 7B, the plural image frames 1101₁ through 1101_{E} are consecutively read at a frame rate of 24-30 frames/second from the start to end of the display operations. According to moving image display method (2) of FIG. 7B, the first image frame 1101₁ of the plural image frames 1101 corresponding to a display start image is read plural times in a repetitive manner. In this case, the image display operations involve displaying a still image at the beginning and then switching to moving image display after a predetermined time period. The frame reading speed in this example may also be 24-30 frames/second. It is noted that the normal mode 502 of FIG. 6 employs the moving image display method (1) of FIG. 7B in combination with a scheme for stopping/proceeding with the moving image display operations based on detection results of the detection unit 403 pertaining to operations by the operator (operator-operation status) and internal conditions of the image forming apparatus, for example. The still image mode 503 of FIG. 6 employs the moving image display method (2) of FIG. 7B. The demo mode 504 employs the moving image display method (1) of FIG. 7B.

### EXAMPLE 1

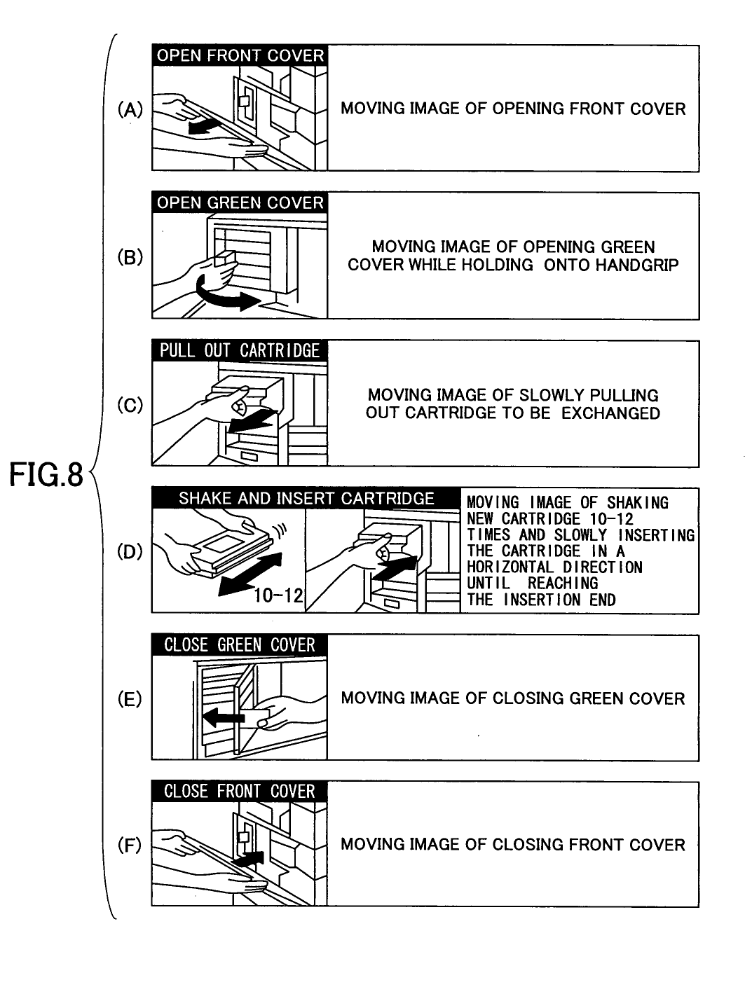

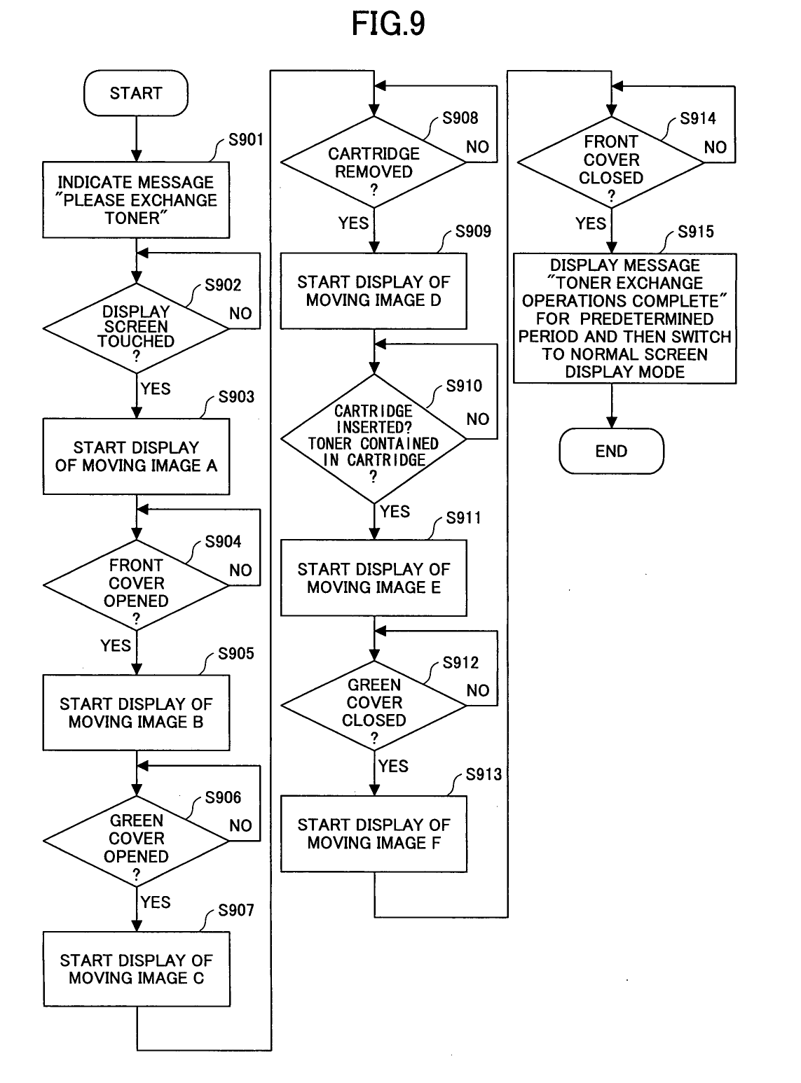

In the following, moving image data according to a first example and a method for displaying such moving image data are described with reference to FIGS. 8 and 9. Specifically, in the present example, the image forming apparatus 400 displays moving images representing toner exchange operation procedures in conjunction with actual operations performed by the operator.

FIG. 8 is a diagram illustrating moving image data of the first example. The moving image data of FIG. 8 describe toner exchange operation procedures and are divided into six sections, (A) through (F), each representing a procedure step of the toner exchange operation procedures. Specifically, FIG. 8(A) illustrates a moving image of opening a front cover, FIG. 8(B) illustrates a moving image of opening a green cover while holding onto a handgrip, FIG. 8(C) illustrates a moving image of slowly pulling out a cartridge to be exchanged, FIG. 8(D) illustrates a moving image of shaking a new cartridge 10-12 times and slowly inserting the new cartridge in a parallel direction until reaching an insertion end, FIG. 8(E) illustrates a moving image of closing the green cover, and FIG. 8(F) illustrates a moving image of closing the front cover. These moving images (A)-(F) are compiled into moving image data including image frame data to be read at a frame rate of 24-30 frames/second. In one embodiment, the moving image data may be accompanied by audio data describing the operation procedures represented by the moving image data, and the audio data may be replayed in accordance with the display of moving images of the operation procedure steps.

FIG. 9 is a flowchart illustrating operations for displaying moving images of the toner exchange operation procedures of the first example. It is noted that the moving image display operations are described below with reference to FIG. 8 as well.

According to the present example, when the detection unit 403 detects that toner exchange operations need to be performed, the display unit 404 displays a warning message stating “Please Exchange Toner” on the display screen (step S901). Then, the detection unit 403 detects whether the operations start input key of the operations input unit 407 has been pressed (step S902). When the detection unit 403 detects that the operations start input key has been pressed (step S902, YES), the display unit 404 displays the moving image of opening the front cover shown in FIG. 8(A) (step S903). Then, the detection unit 403 detects whether the front cover has been opened (step S904). When the detection unit 403 detects that the front cover has been opened (step S904, YES), the display unit 404 displays the moving image of opening the green cover while holding onto the handgrip shown in FIG. 8(B) (step S905). Then, the detection unit 403 detects whether the green cover has been opened (step S906). When the detection unit 403 detects that the green cover has been opened, the display unit 404 displays the moving image of slowly pulling out the cartridge to be exchanged shown in FIG. 8(C) (step S907). Then, the detection unit 403 detects whether the cartridge has been pulled out (step S908). When the detection unit 403 detects that the cartridge has been pulled out (step S908, YES), the display unit 404 displays the moving image of shaking a new cartridge 10-12 times and slowly inserting the new cartridge to an insertion end in a parallel manner shown in FIG. 8(D) (step S909). Then, the detection unit 403 detects whether the new cartridge has been inserted and whether toner is contained therein (step S910). When the detection unit 403 detects that a toner cartridge containing toner has been inserted (S910, YES), the display unit 404 displays the moving image of closing the green cover shown in FIG. 8(E) (step S911). Then, the detection unit 403 detects whether the green cover has been closed (step S912). When the detection unit 403 detects that the green cover has been closed (step S912, YES), the display unit 404 displays the moving image of closing the front cover shown in FIG. 8(F) (step S913). Then, the detection unit 403 detects whether the front cover has been closed (step S914). When the detection unit 403 detects that the front cover has been closed (step S914, YES), the display unit 404 displays a message stating “Toner Exchange Operations Complete” (step 915). In the case where the image data are accompanied by audio data, audio corresponding to each procedure step may be replayed along with the display of the corresponding moving image. Also, in one preferred embodiment, when it is detected during the moving image display operations that operations by the operator are ahead of the operation procedure step represented by the moving image that is currently being displayed, the display of the corresponding moving image is stopped, and a moving image representing a subsequent operation procedure step is displayed.

According to an aspect of the present example, moving image display operations pertaining to predetermined operation procedures may be started by an operator as is necessary or desired, and moving images and/or audio describing the operation procedures may be displayed/replayed step by step so that the operator may accurately perform the operation procedures without knowing the operation procedure steps. According to another aspect of the present example, image/audio data pertaining to a next operation procedure step may not be displayed/replayed until it is determined that a current operation procedure step has been accurately performed by the operator so that a novice operator may easily and accurately perform the operation procedures. According to another aspect of the present example, adequate consideration may be given to operations by the operator, namely, image/audio data pertaining to a next operation procedure step may be displayed/replayed before display/replay of image/audio data pertaining to a current operation procedure is completed upon detecting that the current operation procedure step has been completed by the operator so that an experienced operator may efficiently and accurately perform the operation procedures.

### EXAMPLE 2

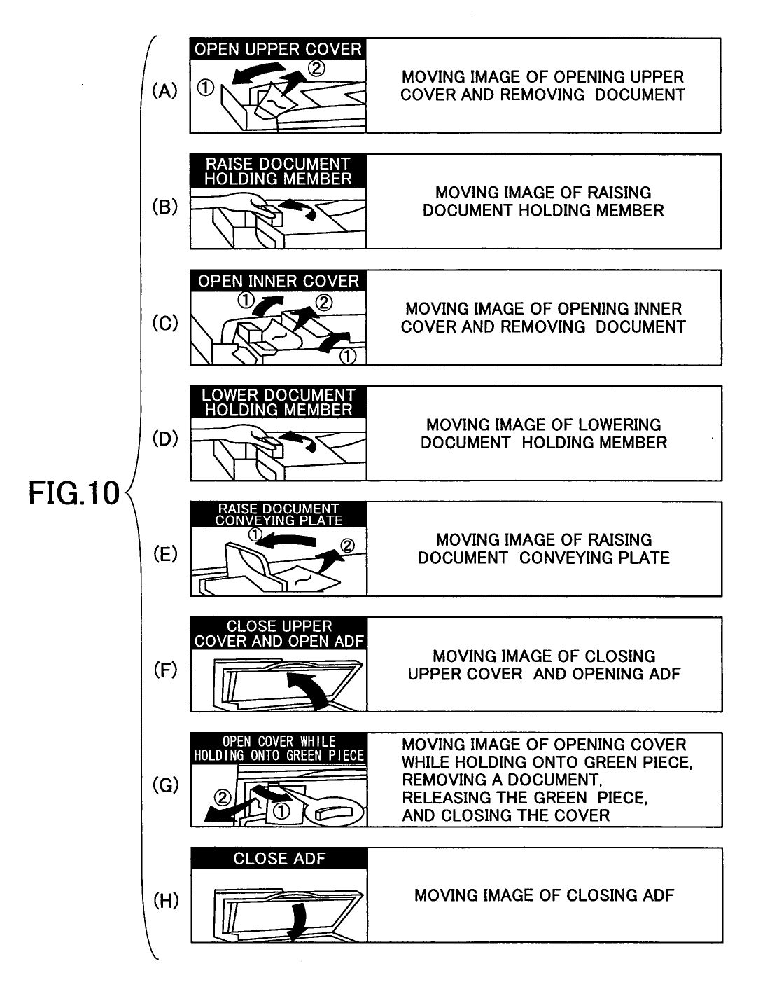

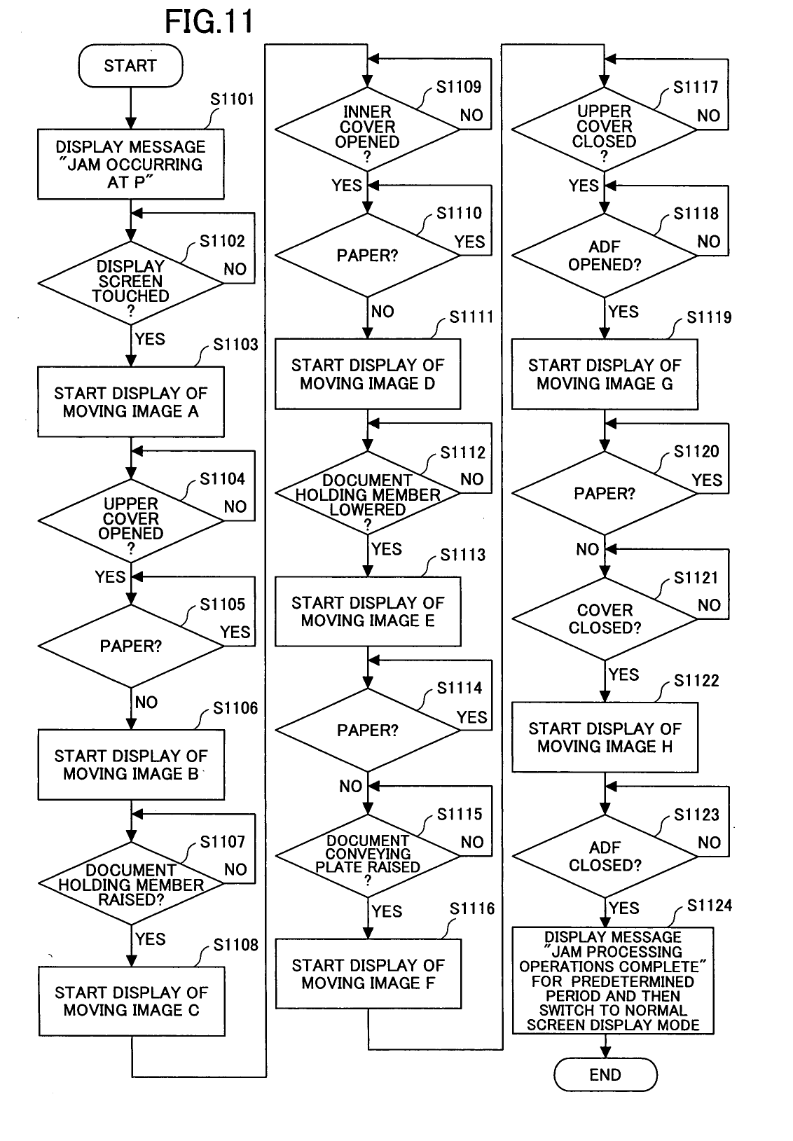

In the following, moving image data of a second example and a method for displaying such moving image data are described with reference to FIGS. 10 and 11. Specifically, in the present example, the image forming apparatus 400 displays moving images representing jam processing operation procedures in conjunction with actual operations performed by the operator.

FIG. 10 is a diagram illustrating moving image data of the second example. The moving image data of FIG. 10 describes jam processing operation procedures and are divided into eight sections, (A) through (H), each representing a procedure step of the jam processing operations procedures. Specifically, FIG. 10(A) illustrates a moving image of opening an upper cover and removing a document; FIG. 10(B) illustrates a moving image of raising a document holding member; FIG. 10(C) illustrates a moving image of removing an inner cover; FIG. 10(D) illustrates a moving image of lowering the document holding member; FIG. 10(E) illustrates a moving image of raising a document conveying plate and removing a document; FIG. 10(F) illustrates a moving image of closing the upper cover and opening an ADF (automatic document feeder); FIG. 10(G) illustrates a moving image of holding onto a green piece, opening a cover of the ADF, removing a document, releasing the green piece, and closing the cover; and FIG. 10(H) illustrates a moving image of closing the ADF. These moving images (A) through (H) are compiled into moving image data including image frame data to be read at a frame rate of 24-30 frames/second, for example. In one embodiment, audio data may be provided along with the moving image data, and in this case the audio data corresponds to audio describing the operation procedure steps represented by the moving image data.

FIG. 11 is a flowchart illustrating process steps for displaying the moving images of the jam processing operation procedures of the second example. It is noted that the moving image display operations are described below with reference to FIG. 10 as well.

According to the present example, when the detection unit 403 detects that a jam has occurred at a certain location P, the display unit 404 displays a warning message stating “Jam Occurring at P” on the display screen (step S1101). Then, the detection unit 403 detects whether the operations start input key of the operations input unit 407 has been pressed (step S1102). When the detection unit 403 detects that the operations start input key of the operations input unit 407 has been pressed (step S1102, YES), the display unit 404 displays the moving image of opening the upper cover and removing a document show in FIG. 10(A) (step 1103). Then, the detection unit 403 detects whether the upper cover has been opened (step S1104). Upon detecting that the upper cover has been opened (step S1104, YES), the detection unit 403 then checks for the presence of paper (step S1105). When the detection unit 403 determines that there is no paper (S1105, NO), the display unit 404 displays the moving image of raising the document holding member shown in FIG. 10(B) (step S1106). Then, the detection unit 403 detects whether the document holding member has been raised (step S1107). When the detection unit 403 detects that the document holding member has been raised (step S1107, YES), the display unit 404 displays the moving image of opening the inner cover and removing a document shown in FIG. 10(C)(step S1108). Then, the detection unit 403 detects whether the inner cover has been opened (step S1109). Upon detecting that the inner cover has been opened (step S1109, YES), the detection unit 403 then checks for the presence of paper (step S1110). When the detection unit 403 detects that there is no paper (step S1110, NO), the display unit 404 displays the moving image of lowering the document holding member shown in FIG. 10(D) (step S1111). Then, the detection unit 403 detects whether the document holding member has been lowered (step S1112). When the detection unit 403 detects that the document holding member has been lowered (step S1112, YES), the display unit 404 displays the moving image of raising the paper conveying plate and removing a document shown in FIG. 10(E) (step S1113). Then, the detection unit 403 checks for the presence of paper (step S1114). Upon determining that there is no paper (step S1114, NO) the detection unit 403 then detects whether the paper conveying plate has been raised (step S1115). When the detection unit 403 detects that the paper conveying plate has been raised (step S1115, YES), the display unit 404 displays the image of closing the upper cover and opening the ADF shown in FIG. 10(F) (step S1116). Then, the detection unit 403 detects whether the upper cover has been closed (step S1117). Upon detecting that the upper cover has been closed (step S1117, YES), the detection unit 403 detects whether the ADF has been opened (step S1118). When the detection unit 403 detects that the ADF has been opened (step S1118, YES), the display unit 404 displays the moving image of holding onto the green piece, opening the cover of the ADF, removing a document, releasing the green piece, and closing the cover shown in FIG. 10(G) (step S1119). Then, the detection unit 403 checks for the presence of paper (step S1120). Upon determining that there is no paper (step S1120, NO), the detection unit 403 then detects whether the cover of the ADF has been closed (step S1121). When the detection unit 403 detects that the cover of the ADF has been closed (step S1121, YES), the display unit 404 displays the moving image of closing the ADF shown in FIG. 10 (H) (step S1122). Then, the detection unit 403 detects whether the ADF has been closed (step S1123). When the detection unit 403 detects that the ADF has been closed (step S1123, YES), the display unit 404 displays a message stating “Jam Processing Operations Complete” on the display screen (step S1124). In the case where audio data is provided along with the moving image data, audio describing the operation procedures may be replayed step by step along with the display of the moving images, for example. Also, in a preferred embodiment, when it is detected during the moving image display operations that the operations performed by the operator is ahead of the operation procedure step represented by the moving image that is currently being displayed, the display of the moving image of the corresponding operation procedure step is stopped, and a moving image of a subsequent operation procedure step is displayed.

According to an aspect of the present example, moving image display operations pertaining to predetermined operation procedures may be started by an operator as is necessary or desired, and moving images and/or audio describing the operation procedures may be displayed/replayed step by step so that the operator may accurately perform the operation procedures without knowing the operation procedure steps. According to another aspect of the present example, image/audio data pertaining to a next operation procedure step may not be displayed/replayed until it is determined that a current operation procedure step has been accurately performed by the operator so that a novice operator may easily and accurately perform the operation procedures. According to another aspect of the present example, adequate consideration may be given to operations by the operator, namely, image/audio data pertaining to a next operation procedure step may be displayed/replayed before display/replay of image/audio data pertaining to a current operation procedure is completed upon detecting that the current operation procedure step has been completed by the operator so that an experienced operator may efficiently and accurately perform the operation procedures.

According to a preferred embodiment of the present invention, moving images may be displayed at a frame rate of 24-30 frames/second so that the operation procedures may be displayed at a speed that is close to the speed at which the operation procedures are actually performed to thereby facilitate understanding by the operator, for example. In another preferred embodiment, the display screen of the display unit 404 may be arranged to be positionally adjustable as is illustrated in FIGS. 5(A), (B), and (C) so that the operator may be able to view the moving image display when he/she is actually performing the relevant operation procedures, for example. In another preferred embodiment, the normal mode 502, the still image mode 503, and the demo mode 504 may be provided as operation mode options at the moving image display mode input unit 501 of the operations input unit 407 as is shown in FIG. 6. In this way, the manner in which image/audio data are displayed/replayed may not be limited to the step by step display/replay of moving images/audio as is described above. For example, in the demo mode 504, moving images describing predetermined operation procedures may be consecutively displayed so that the operator may view the overall sequence of the operation procedures. In another preferred embodiment, moving images and/or audio may be displayed/replayed in conjunction with actual operations performed by the operator so that the operator may not be lost as a result of missing certain parts of the moving images and/or audio, for example.

It is noted that the moving image data of the first example and the second example and the methods for displaying such moving image data are not limited to implementation in the above-described first embodiment of the present invention, and may equally be used in other applications including the second through fourth embodiments described below.

### Second Embodiment

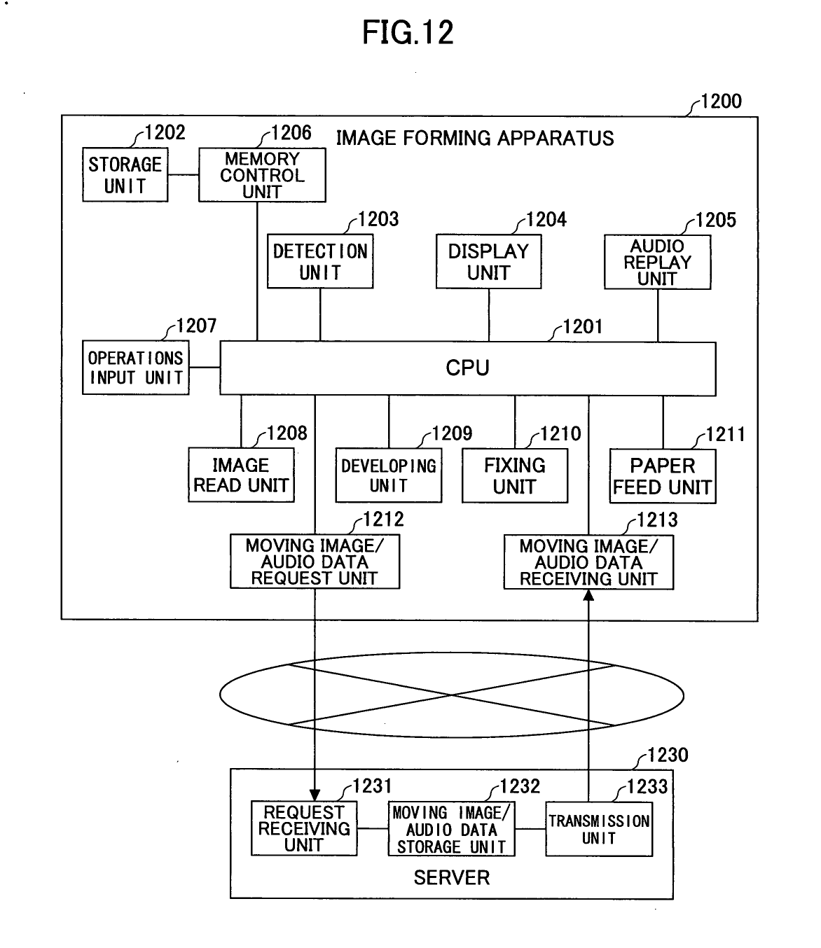

In the following, an image forming apparatus according to a second embodiment of the present invention is described with reference to FIGS. 12-14.

FIG. 12 is a block diagram illustrating a configuration of an image forming apparatus according to the second embodiment that uses a network. The illustrated image forming apparatus 1200 of FIG. 12 includes a CPU 1201, a storage unit 1202, a detection unit 1203, a display unit 1204, an audio replay unit 1205, a memory control unit 1206, an operations input unit 1207, an image read unit 1208, a developing unit 1209, a fixing unit 1210, a paper feed unit 1211, a moving image/audio data request unit 1212, and a moving image/audio data receiving unit 1213. The image forming apparatus 1200 is connected to a server 1230 via a network such as the Internet or a LAN. The server 1230 includes a request receiving unit 1231, a moving image/audio data storage unit 1232, and a transmission unit 1233.

In the following, the moving image/audio data request unit 1212, the moving image/audio data receiving unit 1213, the server 1230, the request receiving unit 1231, the moving image/audio data storage unit 1232, and the transmission unit 1233 are described. It is noted that the components of the image forming apparatus 1200 other than the above-mentioned components are substantially identical to those of the image forming apparatus 400 according to the first embodiment so that descriptions thereof are omitted.

The moving image/audio data request unit 1212 is informed of the detection by the detection unit 1203 of an abnormality occurring in the image forming apparatus 1200 and sends a request signal to the server 1230 requesting for moving image data and/or audio data pertaining to operation procedures for responding to the detected abnormality.

The moving image/audio data receiving unit 1213 receives the moving image data and/or audio data requested by the moving image/audio data request unit 1212.

The request receiving unit 1231 receives the request signal requesting for the moving-image data and/or audio data pertaining to operation procedures for responding to the detected abnormality from the moving image/audio data request unit 1212 of the image forming apparatus 1200.

The moving image/audio data storage unit 1232 stores moving image data and/or audio data pertaining to operation procedures.

The transmission unit 1233 transmits requested moving image data and/or audio image data that are stored in the moving image/audio data storage unit 1232 to the image forming unit 1200 based on the request signal received by the request receiving unit 1231.

In the following, operations of the image forming apparatus 1200 according to the second embodiment are described.

In the present embodiment, the detection unit 1203 determines whether there is an abnormality occurring in the image forming apparatus 1200. When the detection unit 1203 detects an abnormality in the image forming apparatus 1200, the moving image/audio data request unit 1212 sends a request for moving image data and/or audio data pertaining to operation procedures to the server 1230 based on the detection result of the detection unit 1203. The server 1230 receives this request at the request receiving unit 1231 and transmits the requested moving image data and/or audio data to the image forming apparatus 1200 using the transmission unit 1233. The image forming apparatus 1200 receives the transmitted moving image data and/or audio data at the moving image/audio data receiving unit 1213 and stores the received moving image data and/or audio data in the storage unit 1202. The stored moving image data and/or audio data are read by the memory control unit 1206 so that the moving image data may be displayed by the display unit 1204 and the audio data may be replayed by the audio replay unit 1205.

According to an aspect of the present embodiment, the image forming apparatus 1200 does not have to store moving image data and/or audio data pertaining to operation procedures beforehand and may obtain moving image data and/or audio data from the server 1230 via a communication network when an abnormality occurs within the image forming apparatus. According to another aspect of the present embodiment, moving image data and/or audio data pertaining to operation procedures may be regularly updated at the server 1230 side as is necessary or desired, and a large capacity memory does not have to be provided at the image forming apparatus 1200 side. In this way, up-to-date moving image data and/or audio data pertaining to operation procedures may be displayed/replayed.

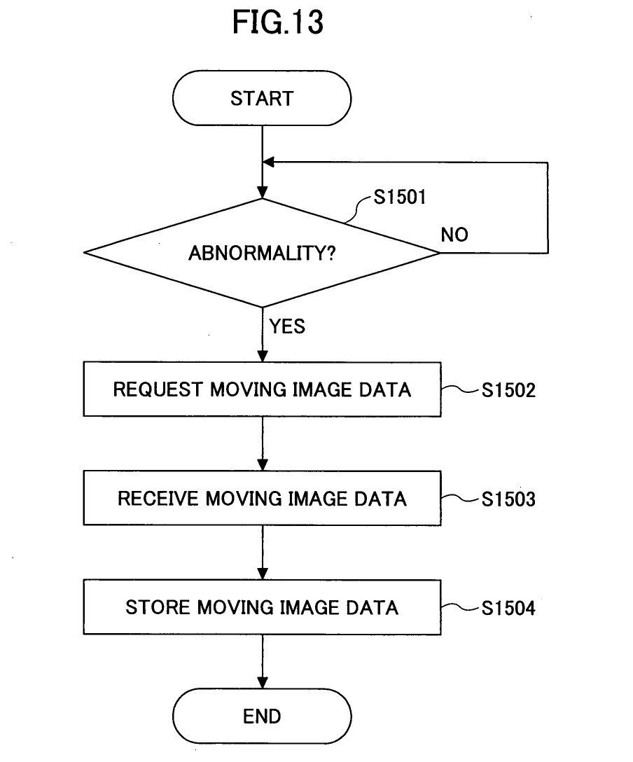

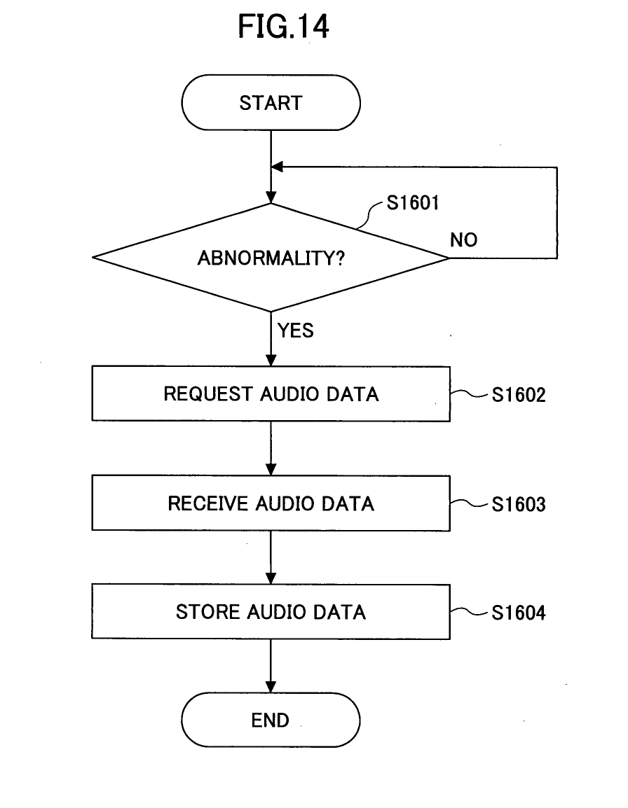

In the following, operations of the image forming apparatus 1200 receiving the moving image data and/or audio data stored at the server 1230 and storing the received data in the storage unit 1202 are described with reference to FIGS. 13 and 14.

FIG. 13 is a flowchart illustrating operations of the image forming apparatus 1200 for receiving moving image data stored in the server 1230 using the network shown in FIG. 12 and storing the received data. As is shown in this drawing, the image forming apparatus 1200 determines whether an abnormality is detected by the detection unit 1203 (step S1501). If an abnormality is detected (step S1501, YES), the image forming apparatus 1200 sends a request for image data to the server 1230 (step S1502). Then, the image forming apparatus 1200 receives the requested image data from the server 1230 (step 1503) after which it stores the received image data in the storage unit 1202 (step 1504).

FIG. 14 is a flowchart illustrating operations of the image forming apparatus 1200 for receiving audio data stored in the server 1230 using the network shown in FIG. 12 and storing the received audio data. As is shown in this drawing, the image forming apparatus 1200 determines whether an abnormality is detected by the detection unit 1203 (step S1601). If an abnormality is detected (step S1601, YES), the image forming apparatus 1200 sends a request for audio data to the server 1230 (step S1602). Then, the image forming apparatus 1200 receives the requested audio data from the server 1230 (step 1603) after which it stores the received audio data in the storage unit 1202 (step 1604).

### Third Embodiment

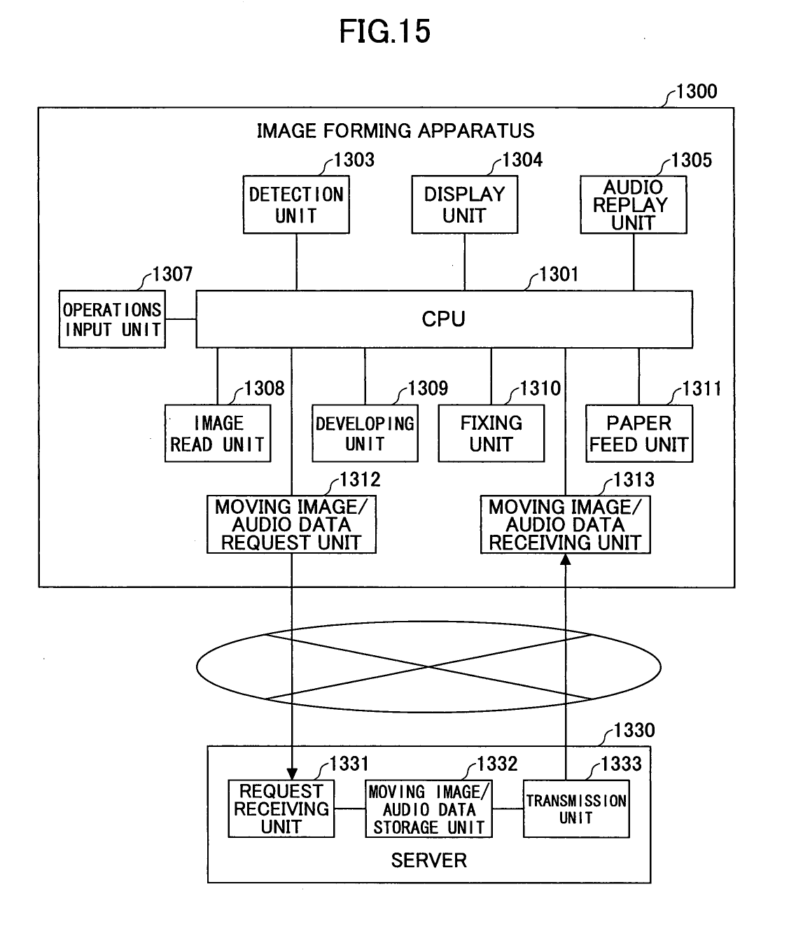

In the following, an image forming apparatus according to a third embodiment of the present invention is described with reference to FIGS. 15-17.

FIG. 15 is a block diagram showing a configuration of the image forming apparatus according to the third embodiment that uses a network. The illustrated image forming apparatus 1300 of FIG. 15 includes a CPU 1301, a detection unit 1303, a display unit 1304, an audio replay unit 1305, an operations input unit 1307, an image read unit 1308, a developing unit 1309, a fixing unit 1310, a paper feed unit 1311, a moving image/audio data request unit 1312, and a moving image/audio data receiving unit 1313.

The image forming apparatus 1300 is connected to a server 1330 via a network such as the Internet or a LAN. The server 1330 includes a request receiving unit 1331, a moving image/audio data storage unit 1332, and a transmission unit 1333.

It is noted that the components of the image forming apparatus 1300 are substantially identical to those of the previously described embodiments of the present invention so that descriptions thereof are omitted.

In the following, operations of the image forming apparatus 1300 according to the third embodiment are described.

In the present embodiment, the detection unit 1303 determines whether there is an abnormality occurring in the image forming apparatus 1300. When the detection unit 1303 detects an abnormality in the image forming apparatus 1300, the moving image/audio data request unit 1312 sends a request for moving image data and/or audio data pertaining to operation procedures to the server 1330 based on the detection result of the detection unit 1303. The server 1330 receives this request at the request receiving unit 1331 and transmits the requested moving image data and/or audio data to the image forming apparatus 1300 using the transmission unit 1333. The image forming apparatus 1300 receives the transmitted moving image data and/or audio data at the moving image/audio data receiving unit 1313 so that the received moving image data may be displayed by the display unit 1304 and the audio data may be replayed by the audio replay unit 1305.

According to an aspect of the present embodiment, the image forming apparatus 1300 does not need to have a storage unit for storing moving image data and/or audio data pertaining to operation procedures beforehand and may obtain moving image data and/or audio data from the server 1330 via a communication network when an abnormality occurs within the image forming apparatus 1300. According to another aspect of the present embodiment, moving image data and/or audio data pertaining to operation procedures may be regularly updated at the server 1330 side as is necessary or desired so that the image forming apparatus 1300 side may display/replay up-to-date moving image data and/or audio data pertaining to operation procedures.

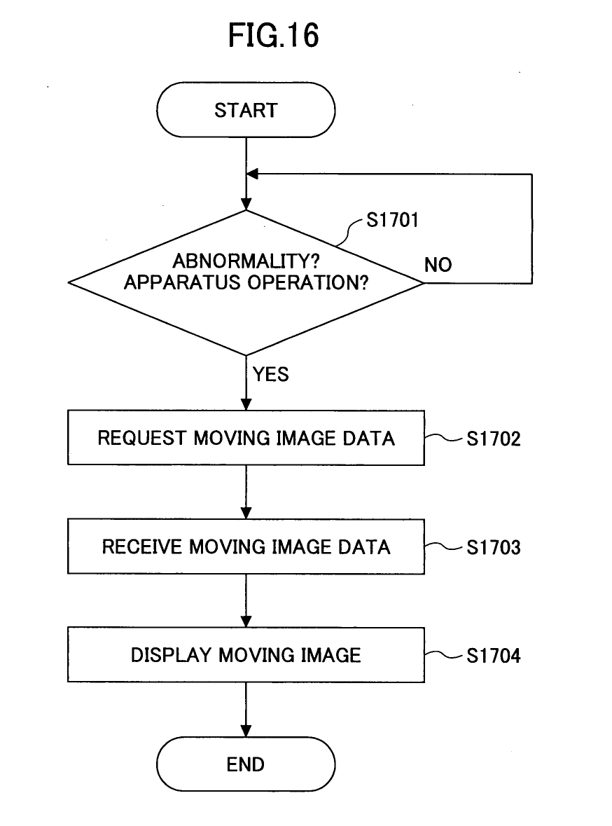

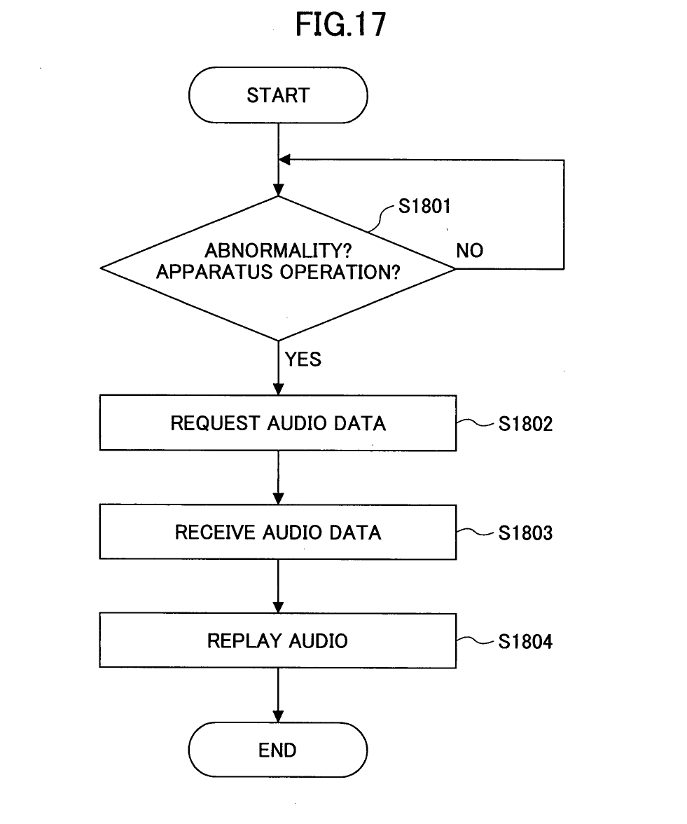

In the following, operations of the image forming apparatus 1300 receiving the moving image data and/or audio data stored at the server 1330 and displaying/replaying the received data by the display unit 1304 or the audio replay unit 1305 are described with reference to FIGS. 16 and 17.

FIG. 16 is a flowchart illustrating operations of the image forming apparatus 1300 for receiving moving image data stored in the server 1330 using the network shown in FIG. 15 and displaying the received moving image data describing operation procedures. As is shown in this drawing, the image forming apparatus 1300 uses the detection unit 1303 to detect an abnormality or operation status of the image forming apparatus 1300 (step S1701). If an abnormality or apparatus operation is detected (step S1701, YES), the image forming apparatus 1300 sends a request for image data to the server 1330 (step S1702). Then, the image forming apparatus 1300 receives the requested image data from the server 1330 (step 1703), and the display unit 1304 displays the received image data (step 1704).

FIG. 17 is a flowchart illustrating operations of the image forming apparatus 1300 for receiving audio data stored in the server 1330 using the network shown in FIG. 15 and replaying the received audio data describing operation procedures. As is shown in this drawing, the image forming apparatus 1300 uses the detection unit 1203 to detect an abnormality or operation status of the image forming apparatus 1300 (step S1801). If an abnormality or apparatus operation is detected (step S1801, YES), the image forming apparatus 1300 sends a request for audio data to the server 1330 (step S1802). Then, the image forming apparatus 1300 receives the requested audio data from the server 1330 (step 1803). Then the audio replay unit 1305 replays the received audio data (step 1804).

### Fourth Embodiment

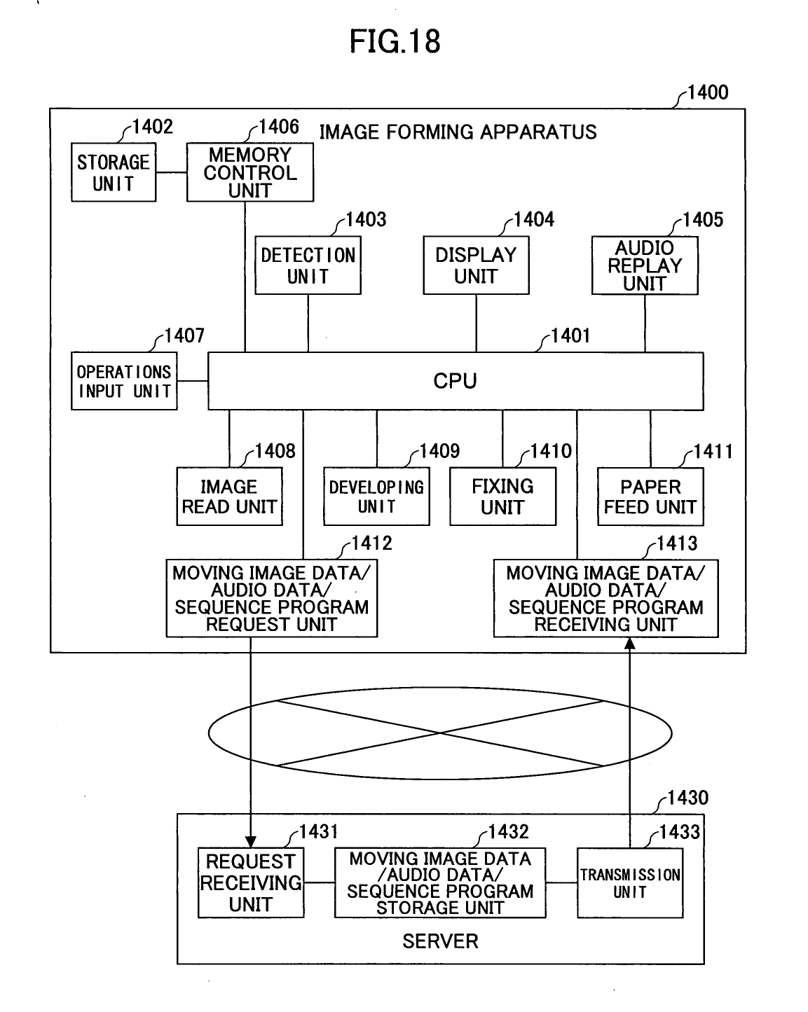

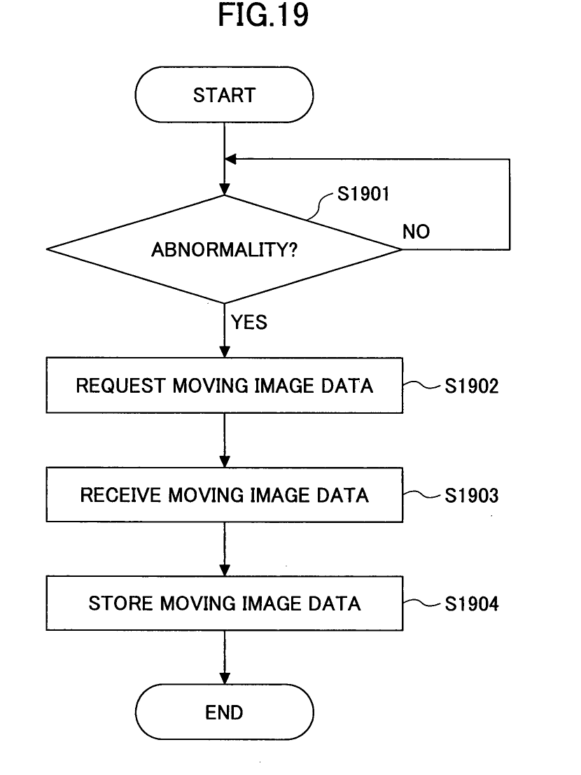

In the following, an image forming apparatus according to a fourth embodiment of the present invention is described with reference to FIGS. 18-21.

FIG. 18 is a block diagram showing a configuration of the image forming apparatus according to the fourth embodiment that uses a network. The illustrated image forming apparatus 1400 of FIG. 18 includes a CPU 1401, a storage unit 1402, a detection unit 1403, a display unit 1404, an audio replay unit 1405, a memory control unit 1406, an operations input unit 1407, an image read unit 1408, a developing unit 1409, a fixing unit 1410, a paper feed unit 1411, a moving image data/audio data/sequence program request unit 1412, and a moving image data/audio data/sequence program receiving unit 1413.

The image forming apparatus 1400 is connected to a server 1430 via a network such as the Internet or a LAN. The server 1430 includes a request receiving unit 1431, a moving image data/audio data/sequence program storage unit 1432, and a transmission unit 1433.

In the following, the moving image data/audio data/sequence program request unit 1412, the moving image data/audio data/sequence program receiving unit 1413, the request receiving unit 1431, the moving image data/audio data/sequence program storage unit 1432, and the transmission unit 1433 are described. It is noted that the components of the image forming apparatus 1400 other than the above-mentioned components are substantially identical to those of the previously described embodiments of the present invention so that descriptions thereof are omitted.

The moving image data/audio data/sequence program request unit 1412 is informed of the detection by the detection unit 1203 of an abnormality occurring in the image forming apparatus 1400 and sends a request signal to the server 1430 requesting for moving image data and/or audio data and a sequence program pertaining to operation procedures for responding to the detected abnormality. It is noted that a sequence program may be a program for controlling display of moving image data as is illustrated in FIGS. 9 and 11, for example. In another example, the sequence program may be a program for controlling replay of audio data.

The moving image data/audio data/sequence program receiving unit 1413 receives the moving image data and/or audio data and the sequence program requested by the moving image data/audio data/sequence program request unit 1412.

The request receiving unit 1431 receives the request signal requesting for the moving image data and/or audio data and the sequence program pertaining to operation procedures for responding to the detected abnormality from the moving image data/audio data/sequence program request unit 1412 of the image forming apparatus 1400.

The moving image data/audio data/sequence program storage unit 1432 stores moving image data and/or audio data and sequence programs pertaining to operation procedures.

The transmission unit 1433 transmits moving image data and/or audio image data and a sequence program stored in the moving image data/audio data/sequence program storage unit 1432 to the image forming unit 1400 based on the request signal received by the request receiving unit 1431.

In the following, operations of the image forming apparatus 1400 according to the fourth embodiment are described.

In the present embodiment, the detection unit 1403 determines whether there is an abnormality occurring in the image forming apparatus 1400. When the detection unit 1403 detects an abnormality in the image forming apparatus 1400, the moving image data/audio data/sequence program request unit 1412 sends a request for moving image data and/or audio data and a sequence program pertaining to predetermined operation procedures to the server 1430 based on the detection result of the detection unit 1403. The server 1430 receives this request at the request receiving unit 1431 and transmits the moving image data and/or audio data and the sequence program being requested to the image forming apparatus 1400 using the transmission unit 1433. The image forming apparatus 1400 receives the transmitted moving image data and/or audio data and the sequence program at the moving image data/audio data/sequence program receiving unit 1413, and stores the received moving image data/audio data/sequence program in the storage unit 1402. The CPU 1401 reads the stored sequence program and uses that read program to control the display unit 1404 to display the stored moving image data and/or control the audio replay unit 1405 to replay the stored moving image data.

According to an aspect of the present embodiment, the image forming apparatus 1400 does not have to store moving image data and/or audio data pertaining to operation procedures beforehand and may obtain moving image data and/or audio data and a sequence program pertaining to relevant operation procedures from the server 1430 via a communication network when an abnormality occurs within the image forming apparatus 1400. According to another aspect of the present embodiment, moving image data and/or audio data and sequence programs pertaining to operation procedures may be regularly updated at the server 1430 side as is necessary or desired, and the image forming apparatus 1400 does not need a large capacity memory. In this way, the image forming apparatus 1400 may display/replay up-to-date moving image data/audio data pertaining to operation procedures.

In the following, operations of the image forming apparatus 1400 receiving moving image data/audio data/sequence program stored at the server 1430 and storing the received moving image data/audio data/sequence program in the storage unit 1402 are described with reference to FIGS. 19-21.

FIG. 19 is a flowchart illustrating operations of the image forming apparatus 1400 for receiving moving image data stored in the server 1430 using the network shown in FIG. 18 and storing the received moving image data. As is shown in this drawing, the detection unit 1303 detect whether an abnormality is occurring in the image forming apparatus 1400 (step S1901). If an abnormality is detected (step S1901, YES), the moving image data/audio data/sequence program request unit 1412 sends a request for image data to the server 1430 (step S1902). Then, the moving image data/audio data/sequence program receiving unit 1413 receives the requested image data from the server 1430 (step 1903). Then, the received image data are stored in the storage unit 1402 (step 1904).

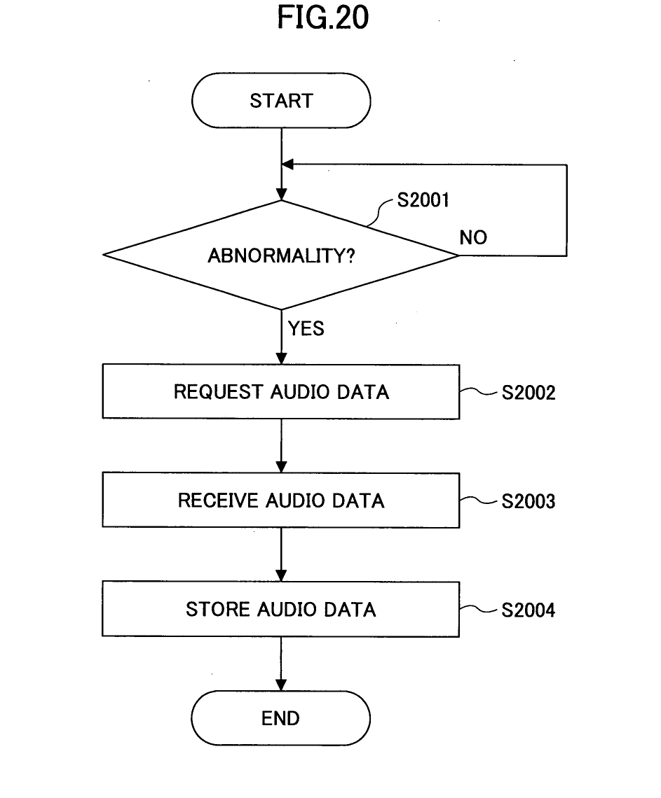

FIG. 20 is a flowchart illustrating operations of the image forming apparatus 1400 for receiving audio data stored in the server 1430 using the network shown in FIG. 18 and storing the received audio data. As is shown in this drawing, the detection unit 1403 detects whether an abnormality is occurring in the image forming apparatus 1400 (step S2001). If an abnormality is detected (step S2001, YES), the moving image data/audio data/sequence program request unit 1412 sends a request for audio data to the server 1430 (step S2002). Then, the moving image data/audio data/sequence program receiving unit 1413 receives the requested audio data from the server 1430 (step 2003). Then, the received audio data are stored in the storage unit 1402 (step 2004).

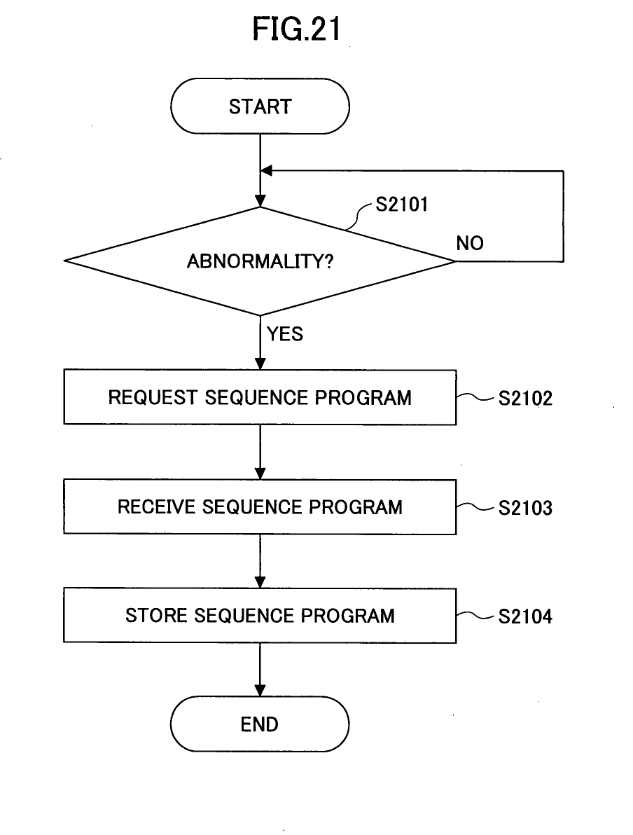

FIG. 21 is a flowchart illustrating operations of the image forming unit 1400 for receiving a sequence program stored at the server 1430 using the network shown in FIG. 18 and storing the received sequence program. As is shown in this drawing, the detection unit 1403 detects whether an abnormality is occurring in the image forming apparatus 1400 (step 2102). If an abnormality is detected (step S2101, YES), the moving image data/audio data/sequence program request unit 1412 sends a request for a sequence program to the server 1430 (step S2102). Then, the moving image data/audio data/sequence program receiving unit 1413 receives the requested sequence program from the server 1430 (step S1203). Then, the received sequence program is stored in the storage unit 1402 (step S1204).

It is noted that in the above-described preferred embodiments of the present invention, moving image data are used as image data describing operation procedures. However, the present invention is not limited to such an embodiment, and other types of image data may be used as well.

Although the present invention is shown and described with respect to certain preferred embodiments, it is obvious that equivalents and modifications may occur to others skilled in the art upon reading and understanding the specification. The present invention includes all such equivalents and modifications, and is limited only by the scope of the claims.

The present application is based on Japanese Patent Application No. 2005-113812 filed on Apr. 11, 2005 and Japanese Patent Application No. 2006-106616 filed on Apr. 7, 2006, and claims the benefit of the earlier filing date of Japanese Patent Application No. 2006-106616. It is noted that the entire contents of the above patent applications are hereby incorporated by reference.

What is claimed is:

1. An image forming apparatus comprising:
an image data storage unit configured to store image data pertaining to operation procedures;
a detection unit configured to detect an abnormality in said image forming apparatus and an operator-operation status of said image forming apparatus;
a read unit configured to read from the image data storage unit relevant image data pertaining to operation procedures relevant to the abnormality and the operator-operation status detected by the detection unit; and
a display unit configured to display the relevant image data read by the read unit.

2. The image forming apparatus as claimed in claim 1, wherein
the image data includes a plurality of consecutive image frames; and
the read unit repeatedly reads a first image frame of the consecutive image frames.

3. The image forming apparatus as claimed in claim 2, wherein
the read unit reads the image data at 24-30 frames/second.

4. The image forming apparatus as claimed in claim 1, further comprising:
an audio data storage unit configured to store audio data pertaining to the operation procedures; and
an audio replay unit; wherein
the read unit reads from the audio data storage unit relevant audio data pertaining to the operation procedures relevant to the abnormality and the operator-operation status detected by the detection unit; and
the audio replay unit replays the relevant audio data read by the read unit.

5. The image forming apparatus as claimed in claim 1, further comprising:
an input unit configured to accept an external operation input; wherein
the detection unit detects the external operation input accepted by the input unit; and
the read unit controls reading of the image data according to the external operation input detected by the detection unit.

6. The image forming apparatus as claimed in claim 1, wherein
the image data correspond to a plurality of operation procedure steps; and
the read unit reads the image data corresponding to the operation procedure steps in sequential order.

7. The image forming apparatus as claimed in claim 6, wherein
the read unit consecutively reads the image data corresponding to the operation procedure steps.

8. The image forming unit as claimed in claim 1, wherein
the display unit includes a display screen of which position is arranged to be adjustable.

9. The image forming apparatus as claimed in claim 1, wherein
the display unit includes a touch panel.

10. The image forming apparatus as claimed in claim 1, further comprising:
a server that includes the image data storage unit storing the image data pertaining to operation procedures; and
an image forming terminal that is connected to the server and includes the detection unit, the read unit, the display unit, an image data request unit configured to send an image data request to the server requesting for the relevant image data included in the image data stored in the image data storage unit when the detection unit detects the abnormality in the image forming apparatus, and an image data receiving unit configured to receive the relevant image data requested by the image data request unit.

11. The image forming apparatus as claimed in claim 10, wherein
the server further includes an audio data storage unit configured to store audio data pertaining to the operation procedures; and
the image forming terminal further includes
an audio data request unit configured to send an audio data request to the server requesting for relevant audio data included in the audio data stored in the audio data storage unit when the detection unit detects the abnormality in the image forming apparatus, the relevant audio data pertaining to operation procedures relevant to the detected abnormality;
an audio data receiving unit configured to receive the relevant audio data requested by the audio data request unit; and
an audio replay unit configured to replay the relevant audio data received by the audio data receiving unit.

12. The image forming apparatus as claimed in claim 11, wherein the image forming terminal further includes
a storage unit configured to store at least one of the relevant image data received by the image data receiving unit and the relevant audio data received by the audio data receiving unit.

13. The image forming apparatus as claimed in claim 11, wherein
the relevant image data received by the image data receiving unit are displayed by the display unit without being stored and the relevant audio data received by the audio data receiving unit are replayed without being stored.

14. The image forming apparatus as claimed in claim 10, wherein
the server further includes a sequence program storage unit configured to store sequence programs for reading and displaying the image data; and
the image forming terminal further includes
a sequence program request unit configured to send a request to the server requesting for a relevant sequence program of the sequence programs stored in the sequence program storage unit when the detection unit detects the abnormality in the image forming apparatus, the relevant sequence program pertaining to reading and displaying the relevant image data;
a sequence program receiving unit configured to receive the relevant sequence program requested by the sequence program request unit; and
a storage unit that stores the relevant image data received by the image data receiving unit and the relevant sequence program received by the sequence program receiving unit.

15. An image forming apparatus comprising:
image data storage means for storing image data pertaining to operation procedures;
detection means for detecting an abnormality in said image forming apparatus and an operator-operation status of said image forming apparatus;
read means for reading from the image data storage means relevant image data pertaining to operation procedures relevant to the abnormality and the operator-operation status detected by the detection means; and
display means for displaying the relevant image data read by the read means.

16. A method of presenting data pertaining to operation procedures of an image forming apparatus which data include image data pertaining to the operation procedures and which image forming apparatus includes a storage unit for storing the data, the method comprising the steps of:
detecting an abnormality in the image forming apparatus and an operator-operation status of the image forming apparatus;
reading from the storage unit relevant image data pertaining to operation procedures relevant to the detected abnormality and operator-operation status; and
displaying the read relevant image data.

17. The method as claimed in claim 16, wherein the data stored in the storage unit of the image forming apparatus includes audio data pertaining to the operation procedures, the method further comprising the steps of:
reading from the storage unit relevant audio data pertaining to operation procedures relevant to the detected abnormality and operator-operation status; and
replaying the read relevant image data.

18. The method as claimed in claim 16, wherein the image forming apparatus further includes a server that includes the storage unit for storing the data and an image forming terminal that is connected to the server, the method further comprising the steps of:
sending an image data request to the server requesting for the relevant image data included in the image data stored in the storage unit upon detecting the abnormality in the image forming apparatus;
receiving the requested relevant image data; and
displaying the received relevant image data.

19. The method as claimed in claim 18, wherein the data stored in the storage unit of the server include audio data pertaining to the operation procedures, the method further comprising the steps of:
sending an audio data request to the server requesting for relevant audio data of the audio data stored in the storage unit upon detecting the abnormality in the image forming apparatus, the relevant audio data pertaining to operation procedures relevant to the detected abnormality;
receiving the requested relevant audio data; and
replaying the received relevant audio data.

20. The method as claimed in claim 18, wherein the data stored in the storage unit of the server include sequence programs for reading and displaying the image data pertaining to the operation procedures, the method further comprising the steps of:
sending a sequence program request to the server requesting for a relevant sequence program of the sequence programs stored in the storage unit upon detecting the abnormality in the image forming apparatus, the relevant sequence program pertaining to reading and displaying the relevant image data;
receiving the requested relevant sequence program; and
reading and displaying the received relevant image data by executing the received relevant sequence program.
